(19) United States
(12) Patent Application Publication
(10) Pub. No.: US 2002/0117187 A1
(43) Pub. Date: Aug. 29, 2002

(54) DOSING METHOD FOR ADDING DETERGENT TO A DISHWASHING MACHINE

(76) Inventor: KARL HELMINGER, AINRING (DE)

Correspondence Address: MERCHANT & GOULD PC, P.O. BOX 2903, MINNEAPOLIS, MN, 55402-0903, US

(21) Appl. No.: 09/331,379

(22) PCT Filed: Dec. 10, 1997
(86) PCT No.: PCT/EP97/06888

(30) Foreign Application Priority Data
Dec. 18, 1996 (DE) 196 52 733.3

(51) Int. Cl. B08B 7/04

(52) U.S. Cl. 134/18; 134/25.2; 134/57 D

(57) ABSTRACT

The invention relates to a commercial dishwashing machine, where the detergent added to the first wash tank of the wash section is controlled by a regulator which controls a dosing device. The regulator is a fuzzy regulator, which in a learning phase determines characteristic influencing values of the system to be regulated. In the learning phase, detergent is continuously added to the first wash tank for a predefined period. The change in the water's conductivity over that period is determined. In the subsequent operating phase, the extent to which the conductivity measured deviates from a set value is determined. Dosing takes place by fuzzy regulation on the set value deviation, on the basis of the measured influencing values as fuzzy variables. Because in the learning phase all the influencing values of the dishwashing machine, dosage device and detergent are taken into account, dosing is automatically optimally adjusted to prevailing conditions.

This invention relates to a metering process for delivering detergent to a dishwashing machine comprising: at least one cleaning tank, a conductivity transducer located in the tank, a spray arm with means for returning the sprayed detergent solution to the cleaning tank and a metering unit for introducing detergent into the cleaning tank.

The dishwashing machine for which the metering process according to the invention is intended is a so-called institutional dishwashing machine of the type used, for example, in large kitchens. Institutional dishwashing machines have at least one cleaning tank which contains water. Water from the cleaning tank is delivered by a pump to a spray arm which sprays the water above the cleaning tank onto the dishes to be washed, the water then dropping back into the cleaning tank. A detergent is added to the water in the cleaning tank by a metering unit. The metering unit is controlled by a controller in dependence upon the concentration of detergent in the cleaning tank. This concentration is determined by a conductivity transducer which makes use of the fact that, given constant temperatures, a high degree of proportionality exists between the concentration of the detergent and the resulting conductivity of the water. The conductivity controller compares the measured value provided by the transducer with a predetermined set value and, if the conductivity falls below the set value, activates a metering valve or a metering pump. When the set value is reached again, the metering valve or the metering pump is switched off.

The control of the addition of detergent is influenced by a number of parameters, for example by the design and size of the dishwashing machine, by the nature and characteristics of the particular detergent and by the water temperature. More particularly, the dead time also has to be taken into account, i.e. the time between the beginning of addition of the detergent and the activation of addition by an increase in conductivity. The intensity of the mixing effect is another important factor in this regard. Influencing factors which influence the control of concentration are mechanical influences, such as positioning of the detergent addition point, positioning of the conductivity measuring cell in the cleaning tank, the length of the rinse-out pipe in the case of powder-form detergent and flow conditions in the wash liquor, and chemical influences, such as the solubility of the detergent and the conductivity/concentration behavior of the detergent. On account of the large number of influencing factors, keeping the concentration of the detergent at the required level is extremely difficult. Under adverse conditions, it is not possible to maintain a constant detergent concentration in the cleaning tank by conventional metering and control processes. For example, the required set value can either be expected to be reached too slowly or significant overconcentrations can be expected to occur. Even if control can be optimized by using a very expensive controller, the control criteria change completely if the slightest changes are made to the dishwashing machine or if another detergent is used, so that the setup of the control system has to be completely changed. However, exact addition of the detergent and strict maintenance of the preset concentration are essential if the dishwashing machine is to operate efficiently with a minimal consumption of detergent.

Process control systems include not only the conventional deterministic control techniques, but also “imprecise” control processes where the input variables are classified as so-called linguistic variables which can assume such states as, for example, “large”, “average” or “small”. In this fuzzy control system, membership functions for the measured variables define the membership values of these imprecise quantities. In a control system, links (WHEN . . . THEN . . . -rules) are established in the sense of the imprecise logic. The result of each rule is an imprecise statement about the output variable (adjustable variable). A numerical value is obtained from this imprecise description by defuzzyfication.

The problem addressed by the present invention was to provide a metering process for delivering a detergent to a dishwashing machine in which metering accuracy in terms of the level attainable would be considerably higher than with conventional controllers.

According to the invention, this problem is solved by the features defined in claim 1.

The metering process according to the invention is based on the application of fuzzy logic which operates with heuristic, imprecise rules. Initially, detergent is introduced into the cleaning tank over a predetermined period in a learning phase. Characteristic influencing factors of the control system are obtained from the system response arising out of this addition. The response consists of a conductivity curve which is established on the basis of the addition. It is so to speak the step response of the control system. Certain influencing factors are determined from it, including for example the dead time, the change in concentration, the equalizing rate and/or the change in the measured value. In the following operating phase, these influencing factors of the control system are processed as heuristic variables, i.e. as imprecise parameters of the control system, by fuzzy control. In the fuzzy control which takes place during the following operating phase, only the measured conductivity value or the setpoint deviation is used as a variable, the other influencing factors originating from the preceding learning phase.

By virtue of the learning phase, all the influencing factors of the entire control system, including those of the transducer, the metering unit and the controller, are taken into consideration.

A new learning phase is preferably always carried out when, during the operating phase, the setpoint deviation exceeds a limit for a predetermined minimum time. In this case, it is assumed that the evaluation of the influencing factors undertaken in the learning phase no longer applies and has to be redone.

Examples of embodiment of the invention are described in detail in the following with reference to the accompanying drawings, wherein:

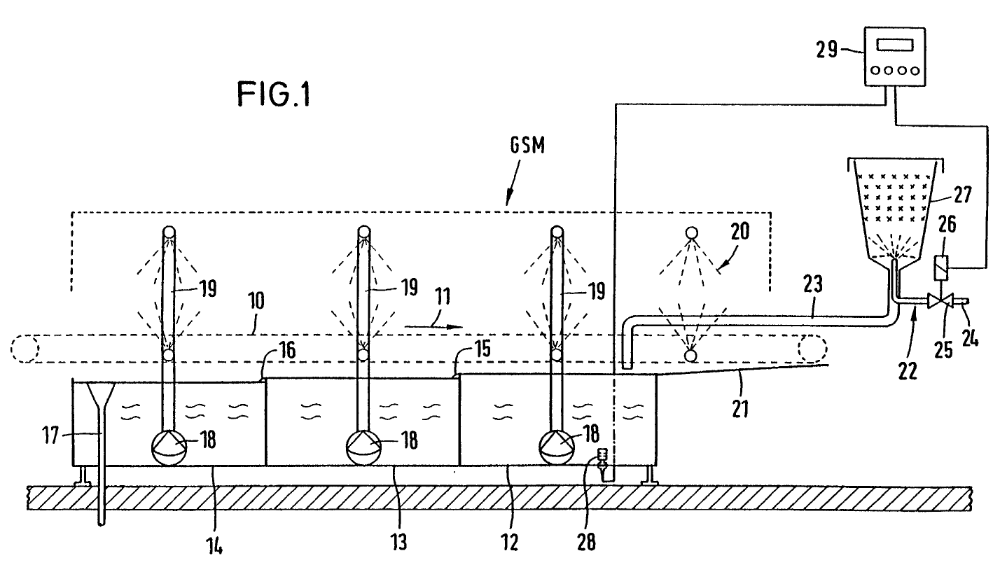

FIG. 1 schematically illustrates an institutional dishwashing machine.

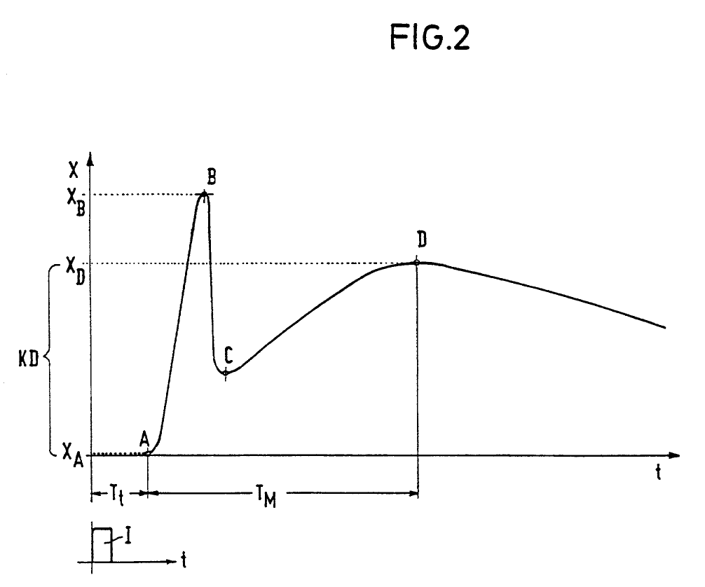

FIG. 2 is an example of a response of the conductivity trend as a function of time during the learning phase.

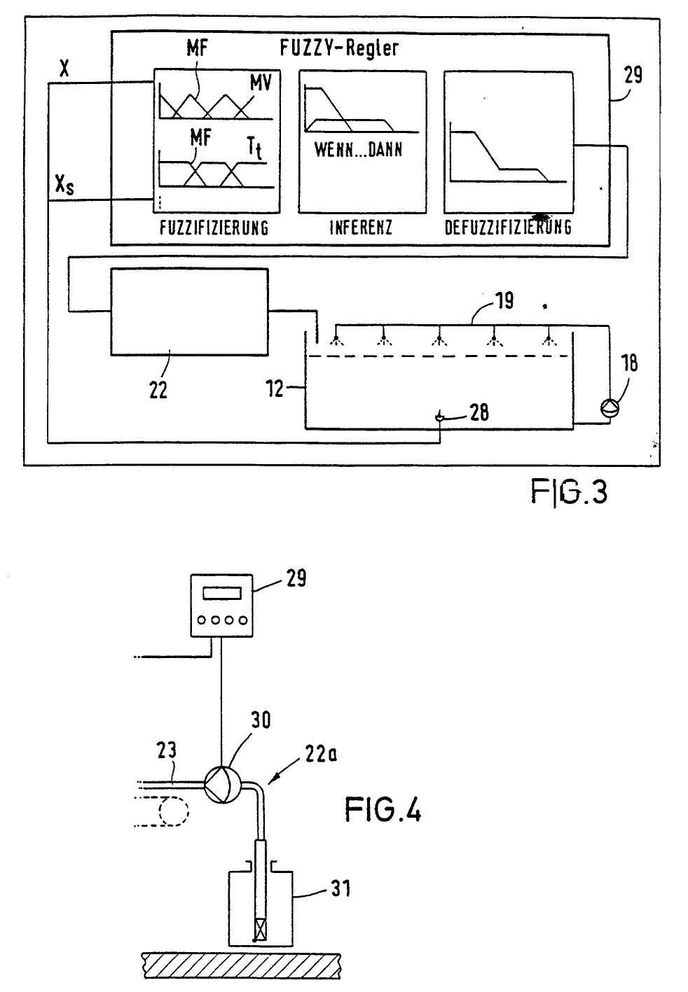

FIG. 3 schematically illustrates the fuzzy controller.

FIG. 4 shows another embodiment of the metering section of a dishwashing machine operated with liquid detergent.

The institutional dishwashing machine GSM shown in FIG. 1 comprises a conveyor section 10 in which the dishes to be cleaned are transported in the direction of the arrow 11. The conveyor section 10 consists of a water-permeable conveyor belt which travels over rollers. Located beneath the conveyor section 10 are a first cleaning tank 12, a second cleaning tank 13 and a third cleaning tank 14 which are arranged in the form of a cascade, the water overflowing from the first cleaning tank 12 into the second cleaning tank 13 via an overflow 15. From the second cleaning tank 13, the water overflows into the third cleaning tank 14 via an overflow 16 and is discharged from the third cleaning tank 14 into an outlet 17. The water travels in the opposite direction to the transport direction 11 of the conveyor section 10.

Arranged in each cleaning tank 12,13,14 is a piston pump 18 which pumps the water from the cleaning tank to a spray arm 19 which sprays the water onto the dishes lying on the conveyor 10. The spray arm 19 is arranged above the open cleaning tank so that the water sprayed from it drops back into the cleaning tank.

Positioned above the end of the conveyor 10 is a rinsing nozzle 20 which sprays the dishes with fresh water that does not come from any of the cleaning tanks. Disposed beneath the rinsing nozzle 20 is a sloping drainage panel 21 which collects the fresh water and guides it into the first cleaning tank 12. The soil content of the water increases steadily from the first cleaning tank 12 to the third cleaning tank 12.

Detergent is introduced through a metering pipe into the first cleaning tank 12 by a metering unit 22. The metering unit 22 is connected to a water pipe 24 and contains a valve 25 which can be opened by an electromagnet 26 to introduce fresh water into a powder container 27. The powder container 27 contains powder-form detergent which is dissolved in the inflowing water. The outlet of the powder container 27 is connected to the metering pipe 23. If the valve 25 is opened for a certain time, a predetermined quantity of water flows into the powder container 27 so that a corresponding amount of detergent is dissolved and introduced into the metering pipe 23.

The concentration of detergent in the water accommodated in the first cleaning tank 12 is determined by a conductivity transducer 28 which is located in the first cleaning tank 12 and which measures the conductivity of the water. A high degree of proportionality exists between the concentration of detergent in the water and the measured conductivity. The electrical output signal of the transducer 28 is fed to a controller 29 which actuates the electromagnet 26 of the valve 25 in dependence upon the measured value. The valve 25 operates solely on the on/off principle.

FIG. 2 shows an example of a response of the signal x of the transducer 28 to a metering pulse I which was generated by the metering unit 22 and during which the valve 25 was opened for a predetermined time tᵥ to deliver detergent to the cleaning tank 12. A dead time Tₜ initially elapses before the detergent produces any reaction from the transducer 28. This dead time takes into account the opening behavior of the valve 25, the dissolving time of the powder-form detergent in the powder container 27 and the flow time of the liquid detergent solution in the metering pipe 23. At A of the response curve, the dead time Tₜ is over and an initially steep increase in conductivity begins up to a point B at which the measured value amounts to x_{B}. This peak may be attributable to the fact that the detergent entering the cleaning tank 12 first moves into the vicinity of the transducer 28 before being distributed in the bath. The measured value then falls to a point C and, finally, undergoes a slow asymptotic increase back to the equalizing value D which represents the last maximum of the curve. This increase is attributable to the fact that mixing takes place in the cleaning tank during the mixing time T_{M} following the dead time Tₜ. The difference between the measured value x_{D} at the time D and the measured value x_{A} at the beginning of activation of the addition is termed the change in concentration KD. The equalizing rate is determined by the time T_{M} between the points A and D of the response curve.

The change in the measured value MD is also determined. This change is determined by the slope of the response curve between the points A and B.

After the last maximum of the response curve at point D, the wash liquor is diluted by the water which enters the cleaning tank 12 through the rinsing section 20 or through another water inlet. This inflow of water takes place continuously both during the learning phase and during the operating phase. The dilution rate W is determined by the gradient of the slope of the response curve after point D. During the learning phase, the piston pump 18 and the spray arm 19 are also in operation.

Accordingly, the influencing factors determined from the response curve during the learning phase are the following:

dead time Tₜ

equalizing rate MV

change in measured value MD

change in concentration KD

dilution rate W.

These influencing factors are stored and processed in the controller 15.

The controller 29 is schematically illustrated in FIG. 3. It is a fuzzy controller in which the influencing factors explained above are fuzzyfied. To this end, certain membership functions MF were established for each influencing factor. These membership functions are triangular curves or trapezoidal curves which divide the various regions of the values of the influencing factors into semantic terms, such as “very high”, “high”, “average”, “low” and “very low”. In the learning phase, the membership value corresponding to the value determined for the influencing factor is determined in the membership function MF. An inference stage contains various “WHEN . . . THEN . . . ” linkages of the various influencing factors. Finally, defuzzyfication takes place to generate the control signal for the metering unit 22.

The linguistic input variables for this example are defined in detail in the following:

Rule 1: Dead Time (Tₜ)

When the time between metering and the first change in conductivity at the measuring cell >12 secs., then dead time=very long.

When the time between metering and the first change in conductivity at the measuring cell >7<12 secs., then dead time=long.

When the time between metering and the first change in conductivity at the measuring cell >4<7 secs., then dead time=average.

When the time between metering and the first change in conductivity at the measuring cell >2<4 secs., then dead time=short.

When the time between metering and the first change in conductivity at the measuring cell <2 secs., then dead time=very short.

Termination of learning phase and alarm signal if dead time >15 secs. because control process no longer under control.

Rule 2: Equalizing Rate MV

When the time between first conductivity change and appearance of the last maximum <2 secs., then equalizing rate=very high.

When the time between first conductivity change and appearance of the last maximum >2 secs.<4 secs., then equalizing rate=high.

When the time between first conductivity change and appearance of the last maximum >4 secs.<7 secs., then equalizing rate=average.

When the time between first conductivity change and appearance of the last maximum >7 secs.<12 secs., then equalizing rate=low.

When the time between first conductivity change and appearance of the last maximum >12 secs., then equalizing rate=very low.

Rule 3: Change in Measured Value MD

When ratio between maximum and minimum conductivity change >10:1, then change in measured value=very fast.

When ratio between maximum and minimum conductivity change >5:1<10:1, then change in measured value=fast.

When ratio between maximum and minimum conductivity change >3:1<5:1, then change in measured value=average.

When ratio between maximum and minimum conductivity change >1:1<3:1, then change in measured value=slow.

When ratio between maximum and minimum conductivity change <1:1, then change in measured value=very slow.

Rule 4: Change in Concentration KD

When average change in conductivity after metering >1.5×Lf alt, then change in concentration=very high.

When average change in conductivity after metering >1.3×Lf alt<1.5×LF alt, then change in concentration=high.

When average change in conductivity after metering >1.1×Lf alt<1.3×LF alt, then change in concentration=average.

When average change in conductivity after metering >1.05×Lf alt<1.1×LF alt, then change in concentration=low.

When average change in conductivity after metering <1.05×LF alt, then change in concentration=very low.

Rule 5: Dilution by Addition of Water VV

When gradient of conductivity change after mixing >−0.1 mS/sec., then dilution=very fast.

When gradient of conductivity change after mixing >−0.05 mS/sec. <−0.1 mS/sec., then dilution=fast.

When gradient of conductivity change after mixing >−0.03 mS/sec. <−0.05 mS/sec., then dilution=average.

When gradient of conductivity change after mixing >−0.01 mS/sec. <0.03 mS/sec., then dilution=slow.

When gradient of conductivity change after mixing <−0.01 mS/sec., then dilution=very slow.

Rule 6: Set Point Deviation □x

When sliding average value of conductivity measurement <proportional range (−), then setpoint deviation=neg. large

When sliding average value of conductivity measurement <proportional range/2>proportional range(−), then setpoint deviation=neg. average

When sliding average value of conductivity measurement=setpoint +/− proportional range/10, then setpoint deviation=zero.

When sliding average value of conductivity measurement=>proportional range/2<proportional range(+), then setpoint deviation=pos. average

When sliding average value of conductivity measurement=>proportional range(+), then setpoint deviation=pos. large.

The linguistic variables according to rules 1 to 5 are determined and stored during the learning phase. They remain unchanged during an operating phase. By contrast, the variable according to rule 6 is continuously determined during the operating phase and the metering unit 22 is controlled in dependence upon its trend as a function of time. To this end, the measured value x of the transducer 28 is fed to the fuzzy controller together with the setpoint x to which conductivity is to be controlled. The setpoint deviation □x=x−xₛ is formed from these two values.

The output signal of the fuzzy controller 29 can assume the following states:

permanently on

on for a very long time

on for a long time

on for an average time

on for a short time

on for a very short time

permanently off.

Some fuzzy rules are set out in the following:

When dead time=very long and setpoint deviation=neg. average, then output=on for an average time.

When dead time=long and setpoint deviation=neg. average, then output=on for a long time.

When dead time=average and setpoint deviation=neg. average, then output=on for a long time.

When dead time=short and setpoint deviation=neg. average, then output=on for a very long time.

When dead time=very short and setpoint deviation=neg. average, then output=permanently on.

It follows from this that the shorter the dead time, the longer metering can be selected to continue because the change in concentration is immediately detected.

When dilution=very fast and setpoint deviation=neg. average, then output permanently on.

When dilution=fast and setpoint deviation=neg. average, then output on for a very long time.

When dilution=average and setpoint deviation=neg. average, then output on for a long time.

When dilution=slow and setpoint deviation=neg. average, then output on for an average time.

When dilution=very slow and setpoint deviation=neg. average, then output on for a short time.

It follows from the above rule that the dilution rate influences the addition time for the same deviation. In other words, the higher the dilution rate, the longer the addition time must be.

Very high control accuracy can be achieved by linking all the fuzzy variables defined in rules 1 to 5.

If, during an operating phase, it is found that the setpoint deviation □x exceeds a limit for a predetermined minimum time, it is assumed that the influencing factors determined in the learning phase no longer apply and a new learning phase is carried out to determine a new response to a metering pulse I.

In FIG. 2, it is assumed that the starting value x_{A} is zero or substantially zero. This is not the case when a certain concentration of detergent is already present in the cleaning tank. Depending on the starting concentration, the influencing factor-measured value change and/or equalizing rate may have to be differently evaluated which can be done by multiplication by a corresponding factor.

In the embodiment shown in FIG. 4, the metering unit 22a contains a pump 30 which pumps the liquid detergent from a liquid container 31 into the metering pipe 23. In this case, the controller 29 controls the pump 30 by switching it on or off.

1. A metering process for delivering detergent to a dishwashing machine comprising: at least one cleaning tank (12), a conductivity transducer (28) located in the cleaning tank, a spray arm (19) with means for returning the sprayed detergent solution to the cleaning tank (12) and a metering unit (22) for introducing detergent into the cleaning tank (12), characterized in that detergent is continuously introduced into the cleaning tank (12) for a predetermined time in a learning phase and the resulting response of the conductivity as a function of time is determined; in that characteristic influencing factors (Tₜ, MV, MD, KV, VV) of the control system are obtained from the response; in that a conductivity setpoint (x_{S}) is adjusted for a following operating phase; and in that, in the operating phase, the setpoint deviation (□x) of the measured conductivity is determined and metering is carried out by a fuzzy control system as a function of the setpoint deviation (□x) on the basis of the determined influencing factors as fuzzy variables.

2. A metering process as claimed in claim 1, characterized in that the influencing factors of the control system obtained from the response comprise at least the dead time (Tₜ), the change in concentration (KD) between the starting value (A) and the last maximum (D) of the response and the equalizing rate (MV) and/or the change in the measured value (MD) between maximum and minimum conductivity.

3. A metering process as claimed in claim 1 or 2, characterized in that the influencing factors of the control system obtained from the response comprise the dilution rate (VV) caused by addition of water after the last maximum (D).

4. A metering process as claimed in any of claims 1 to 3, characterized in that a new learning phase is carried out when the setpoint deviation (□x) exceeds a limit for a predetermined minimum time.

5. A metering process as claimed in any of claims 1 to 4, characterized in that the conductivity value (x) is measured at the beginning of the learning phase and the influencing factor-measured value change and/or the equalizing rate and/or change in concentration is evaluated in dependence thereon.
